(19) United States
(12) Patent Application Publication
(10) Pub. No.: US 2008/0294631 A1
(43) Pub. Date: Nov. 27, 2008

(54) DESIRE POSTING SYSTEM AND METHOD

(75) Inventors: Raed Malhas, Seattle, WA (US); Deniz Erkan, Seattle, WA (US)

Correspondence Address: AXIOS LAW GROUP. PLLC, 1525 FOURTH AVENUE, SUITE 800, SEATTLE, WA, 98101, US

(73) Assignee: MINEEDS, LLC, Seattle, WA (US)

(21) Appl. No.: 12/126,823

(22) Filed: May 23, 2008

Related U.S. Application Data
(60) Provisional application No. 60/939,858, filed on May 24, 2007.

(51) Int. Cl. G06F 17/30

(52) U.S. Cl. 707/5; 707/E17.014

(57) ABSTRACT

Systems and methods are provided herein that provide for desire posting.

### RELATED REFERENCES

This application claims priority to U.S. Provisional Application 60/939,858 filed May 24, 8007, entitled “SYSTEMS AND METHODS FOR USER EXTENSIBLE TAXONOMY.” The foregoing application is hereby incorporated by reference in its entirety as if fully set forth herein.

### FIELD

This invention relates generally to the advertisement and search for goods and/or services, and more specifically, to systems and methods for desire posting.

### BACKGROUND

Commonly, when a person desires goods and services, that person must search for providers of those goods and services and contact each of them individually. This may be a time consuming and difficult process, especially when consumers are not sophisticated and are not sure of what goods and services they need, and are not sure what a fair-market price is.

Additionally, the search experience that exists today on both the web and closed systems (such as desktop storage systems, etc.) is predominantly based on free/unstructured text. Extensible search sites implement a complex process to create a searchable index of this unstructured data. The process typically includes crawling the data on the web or on a closed system, and through different data mining and natural language processing (NLP) algorithms, these systems form indexes that would tag these web sites and systems with context information so that they are searchable.

Although the process of crawling and mining unstructured text creates an inventory of search indexes, it does not support specific structured search experience. For instance, a person may search for ‘houses for rent in Seattle’ and would get lead results to unstructured data sources that might contain houses for rent in the Seattle area. However, such systems lack the ability to consume the search request in a structured way and bring up specific choices, and rather give you leads to choices.

In some systems and websites that exist today, the only extension or modification users may apply to them is by entering, editing, or deleting pure text. For example, posting articles, ‘text’ info or listings, blogs, email, and the like. Entering “text” fields in systems provide little value for the business owners, website administrators, and users because it is difficult for software logic to consume this data in a meaningful and precise manner to produce a customer-targeted outcome that is valuable for both businesses and users.

### BRIEF DESCRIPTION OF THE DRAWINGS

The present invention will be described by way of exemplary embodiments but not limitations, illustrated in the accompanying drawings in which like references denote similar elements, and in which:

FIG. 1 is a pictorial diagram of a system of interconnected devices, in accordance with various embodiments.

FIG. 2 is an illustration of a graphic user interface comprising a search module, in accordance with various embodiments.

FIG. 3 is an illustration of a graphic user interface comprising a provider profile module, in accordance with various embodiments.

FIG. 4 is an illustration of a graphic user interface comprising another provider profile module, in accordance with various embodiments.

FIG. 5 is an illustration of a graphic user interface comprising a further provider profile module, in accordance with various embodiments.

FIG. 6 is an illustration of a graphic user interface comprising a desire posting module, in accordance with various embodiments.

FIG. 7 is an illustration of a graphic user interface comprising another desire posting module, in accordance with various embodiments.

FIG. 8 is a block diagram of a device that provides an exemplary operating environment for various embodiments.

FIG. 9 is a diagram illustrating the actions taken by a provider device and a host server in accordance with various embodiments.

FIG. 10 is a flow diagram illustrating a provider profile setup routine in accordance with various embodiments.

FIG. 11 is a flow diagram illustrating a taxonomy triage sub-routine routine in accordance with various embodiments.

FIG. 12 is a diagram illustrating the actions taken by a user device, a host server, and a provider device, in accordance with various embodiments.

FIG. 13 is a flow diagram illustrating a desire posting routine in accordance with various embodiments.

FIG. 14 is a flow diagram illustrating a desire posting notification sub-routine in accordance with various embodiments.

FIG. 15 is a diagram illustrating the actions taken by a user device and a host server in accordance with various embodiments.

FIG. 16 is a flow diagram illustrating a provider search routine in accordance with various embodiments.

FIG. 17 is a flow diagram illustrating a provider ranking sub-routine in accordance with various embodiments.

FIG. 18 is an illustration of a graphic user interface comprising a desire posting management module, in accordance with various embodiments.

### DESCRIPTION

Illustrative embodiments presented herein include, but are not limited to, systems and methods for desire posting

Various aspects of the illustrative embodiments will be described using terms commonly employed by those skilled in the art to convey the substance of their work to others skilled in the art. However, it will be apparent to those skilled in the art that the embodiments described herein may be practiced with only some of the described aspects. For purposes of explanation, specific numbers, materials and configurations are set forth in order to provide a thorough understanding of the illustrative embodiments. However, it will be apparent to one skilled in the art that the embodiments described herein may be practiced without the specific details. In other instances, well-known features are omitted or simplified in order not to obscure the illustrative embodiments.

Further, various operations and/or communications will be described as multiple discrete operations and/or communications, in turn, in a manner that is most helpful in understanding the embodiments described herein; however, the order of description should not be construed as to imply that these operations and/or communications are necessarily order dependent. In particular, these operations and/or communications need not be performed in the order of presentation.

The phrase “in one embodiment” is used repeatedly. The phrase generally does not refer to the same embodiment; however, it may. The terms “comprising,” “having” and “including” are synonymous, unless the context dictates otherwise.

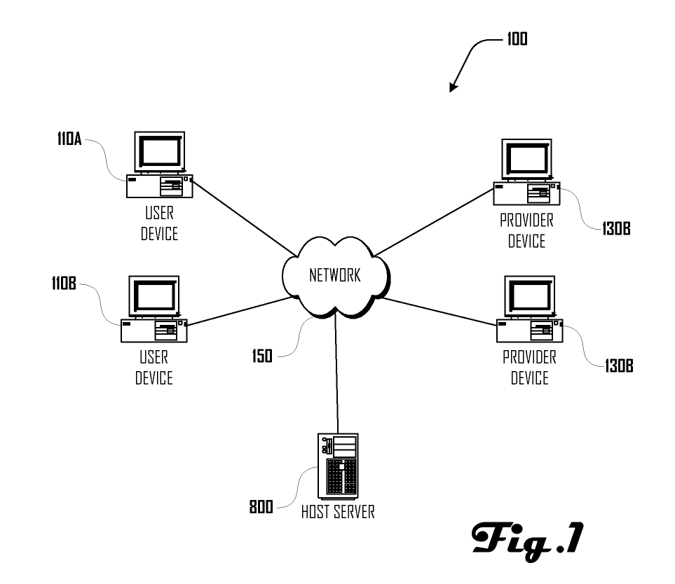

FIG. 1 is a pictorial diagram of a system of interconnected devices 100, in accordance with various embodiments. The system of interconnected devices 100 comprises user devices 110A, 110B, provider devices 130A, 130B, and a host server 800, which are operably connected via a network 150. In one embodiment, there may be a plurality of user devices 110A, 110B and/or a plurality of provider devices 130A, 130B. In another embodiment, there may be a plurality of host servers 800.

In various embodiments, the host server 800 may facilitate one or more user device 110A, 110B to search for providers of goods and/or services by searching for provider profiles corresponding to various providers of goods and/or services. Additionally, one or more user device 110A, 110B may post a desire posting, which may be viewable by other user devices 110A, 110B, or provider devices 130A, 130B. Additionally, one or more provider device 130A, 130B may generate one or more provider profile that corresponds to a provider of goods and/or services. Furthermore, in various embodiments, user devices 110A, 110B, and/or provider devices 130A, 130B may be various types of computer devices, which may include a laptop computer, mobile device, cellular telephone, personal data assistant, gaming system, desktop computer, or the like.

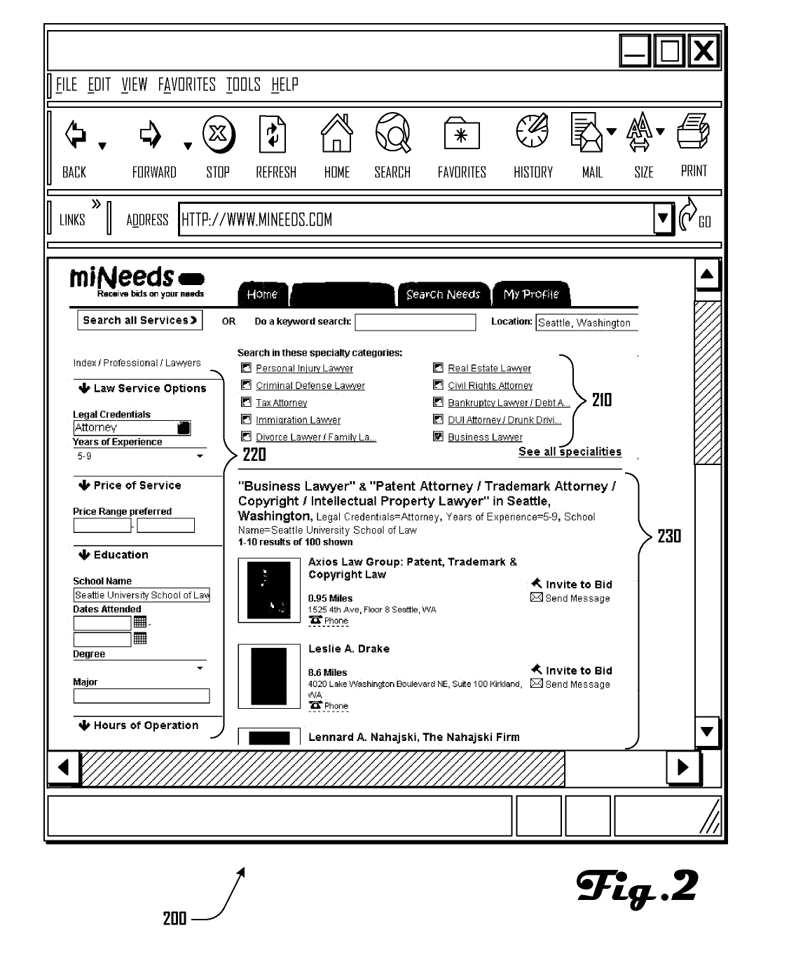

FIG. 2 is an illustration of a graphic user interface comprising a search module 200, in accordance with various embodiments. The search module 200 may allow a user to search for provider profiles that correspond to providers of goods and/or services. The search module 200 comprises a provider definition field 210, a provider attribute field 220, and a provider profile field 230.

For example, in the exemplary embodiment depicted in FIG. 2, a search is shown, wherein a search is being made within a primary category of “Professional” services, and a sub-category of “Lawyers.” Additionally, the provider definition field 210 depicts various specialties within the secondary category of “Lawyers,” which includes definitions such as “Personal Injury Lawyer”, “Criminal Defense Lawyer”, “Tax Attorney”, “Business Lawyer”, and the like. The definition “Business Lawyer” is selected in this depicted exemplary embodiment.

The provider attribute field 220 comprises a plurality of provider attributes that may be selected or defined, which may be attributes such as “Legal Credentials”, “Years of Experience”, Price of Services”, “Education”, Hours of Operation”, and the like. Such attributes may further limit, expand or define, the search criteria of a provider search.

In the embodiment depicted here, the search criteria are depicted in the provider profile field 230 along with provider profiles matching the search criteria ranked in order of most relevant profile in relation to search criteria. In various embodiments, search criteria may be weighted. For example, various attributes and/or definitions may contribute more or less to a score given to a provider profile for correspondence to one or more search criteria, which determines ranking and display of provider profiles.

In one embodiment, there may be multiple score weight-levels of provider attributes and/or provider definitions. For example, definitions in the provider definition field 210 may contribute greatly to a score given to a provider profile, whereas provider attributes selected or defined in the provider attributes field 220 may contribute less to a score given to a provider profile. Such a method may be desirable in various embodiments because all variables of a search may not have equal value to a given searcher.

For example, a user from Seattle may be searching for a dentist to perform a root canal and may configure a search for an endodontist, within close proximity of area code 98101, that has been practicing for 5-10 years, is a female and is Jewish. Clearly, the user may not consider each of these criteria to be equal and it would not be desirable in various embodiments to give each of these criteria equal weight when evaluating and ranking provider profiles. In many embodiments, criteria of practice area would have greatest priority (i.e. being an endodontist), criteria such as proximity and time in practice would have secondary priority, and criteria such as gender and religion would have tertiary priority.

In another embodiment, a user may choose the priority of each of the criteria, for example, by selecting a radio button, moving a sliding scale, entering number, or the like.

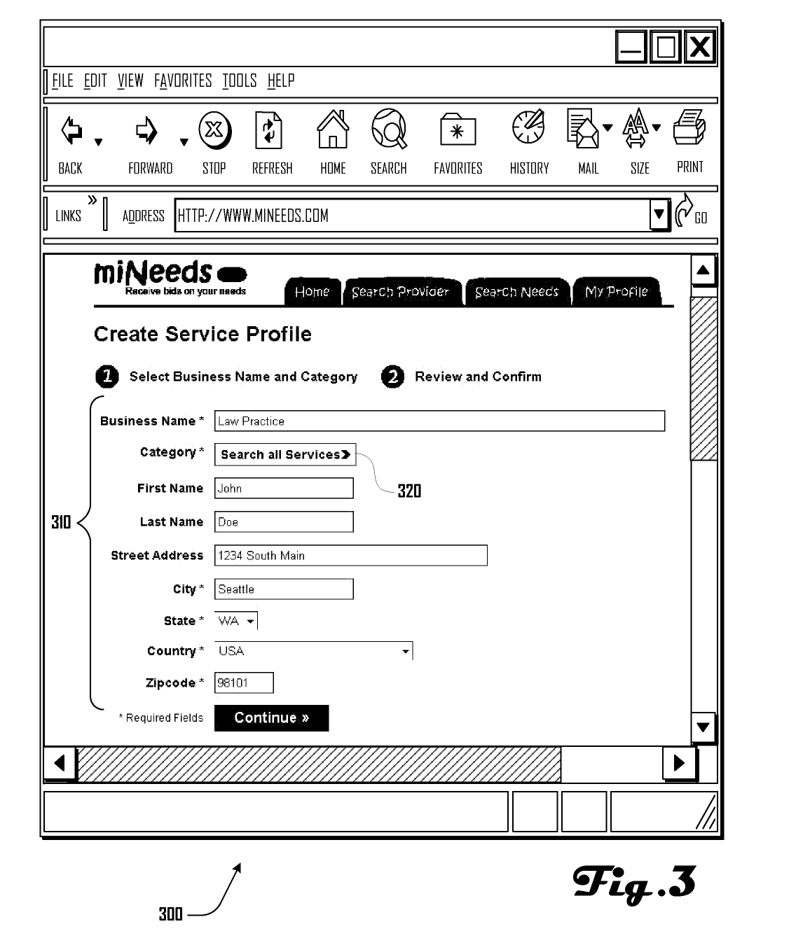

FIG. 3 is an illustration of a graphic user interface comprising a provider profile module 300, in accordance with various embodiments. The exemplary provider module 300 depicted in FIG. 3 comprises a first provider input field 310, which comprises a provider definition field 320. The exemplary provider module 300 depicted in FIG. 3 may allow a provider to input information about the provider such as name of business, name of contact person, address of provider, location of provider, and the like.

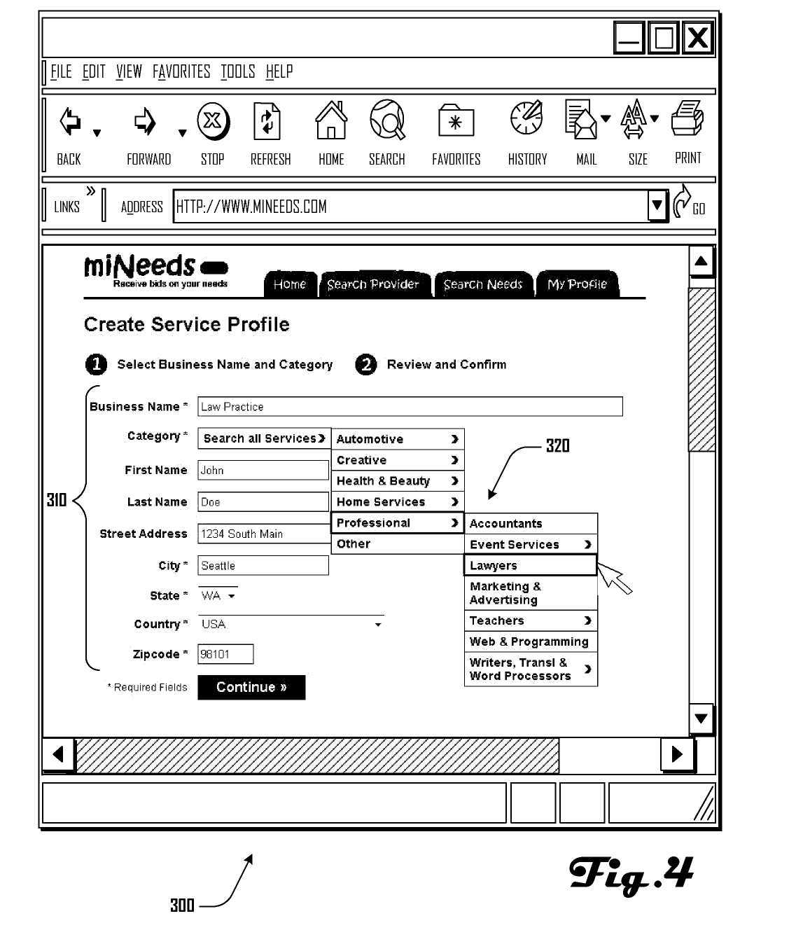

FIG. 4 is an illustration of a graphic user interface comprising a provider profile module 300, in accordance with various embodiments, which comprises a first provider input field 310, which further comprises a provider definition field 320. As shown in FIG. 4, the provider definition field 320 may allow a provider to select a provider definition from within a nested hierarchical taxonomy. The nested hierarchical taxonomy may comprise one or more levels, wherein each level may comprises one or more definition of goods and/or services. The nested hierarchical taxonomy may begin broadly, and become more specific in subsequent levels. In various embodiments, the nested hierarchical taxonomy may be analogous to zoological classification of living creatures. For example, as shown in FIG. 4, a user is depicted selecting “Lawyers” from the broader category of “Professional” services.

In one embodiment, the nested hierarchical taxonomy is extensible by a provider. For example, a provider may add a provider definition to any level of the nested hierarchical taxonomy if the provider so desires. In some embodiments, a provider device 130 and/or a user device 110 may modify, add, or remove a provider definition from any level of the nested hierarchical taxonomy or modify, add, or remove any level of the nested hierarchical taxonomy.

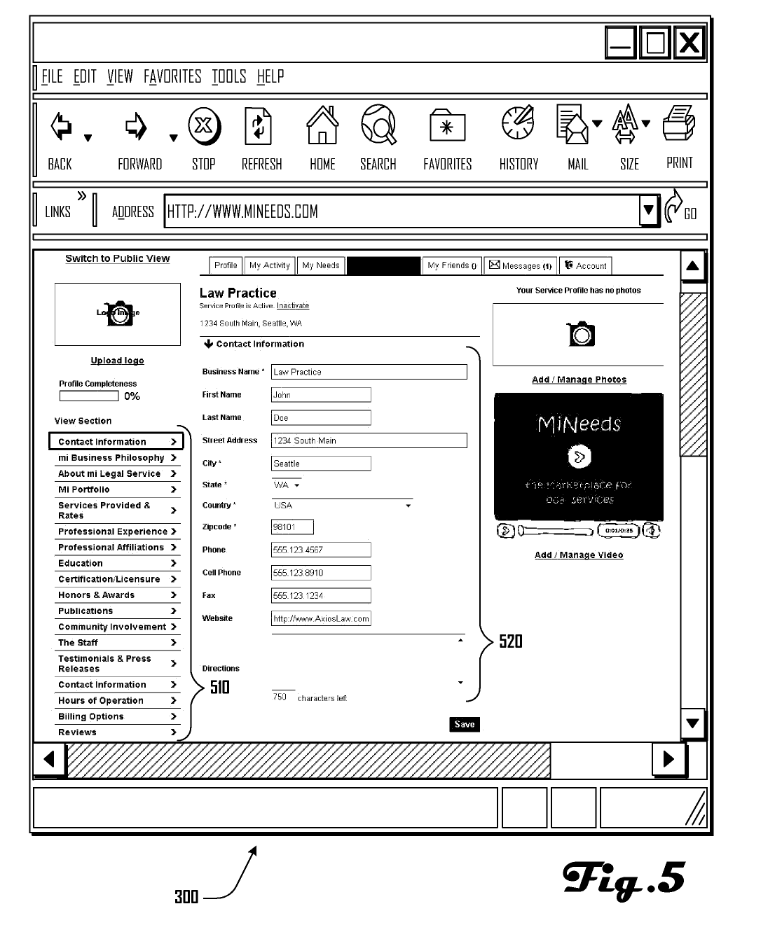

FIG. 5 is an illustration of a graphic user interface comprising a provider profile module 300, in accordance with various embodiments, the provider profile module 300 comprises a second provider input field 520 and a provider input menu 510. The second provider input field 520 allows a provider to input additional information about the provider, define one or more provider attribute, select one or more provider attribute, and the like.

The second provider field 520, as depicted in FIG. 5, allows a provider to define or input contact information. In one embodiment, a provider may input various types of other information about the provider, define, input, modify or select one or more provider attribute, or select, modify, define, or input one or more provider definition.

Provider attributes may be various types of information corresponding to a provider, which may include location, business philosophy, description of provider goods and/or services, a provider portfolio, provider fees and billing structure, professional experience, professional affiliations, education, certification, licensure, honors, awards, publications, community involvement, provider staff, provider members, testimonials, press releases, contact information, hours of operation, reviews of provider goods and/or services, personal information about one or more member or staff person associated with a provider, service area, and the like. It should be clear to one of ordinary skill in the art the vast amount of information that may be gathered about a provider, all of which is within the scope and spirit of various embodiments.

In one embodiment one or more provider attribute may be organized in a nested hierarchical taxonomy comprising one or more level, and a provider may modify, add, remove or otherwise configure the nested hierarchical taxonomy relating to one or more provider attribute. For example, one attribute may be “favorite type of music” and a user may modify the nested hierarchical taxonomy to add a new type of music that is not currently presented if the user so desires.

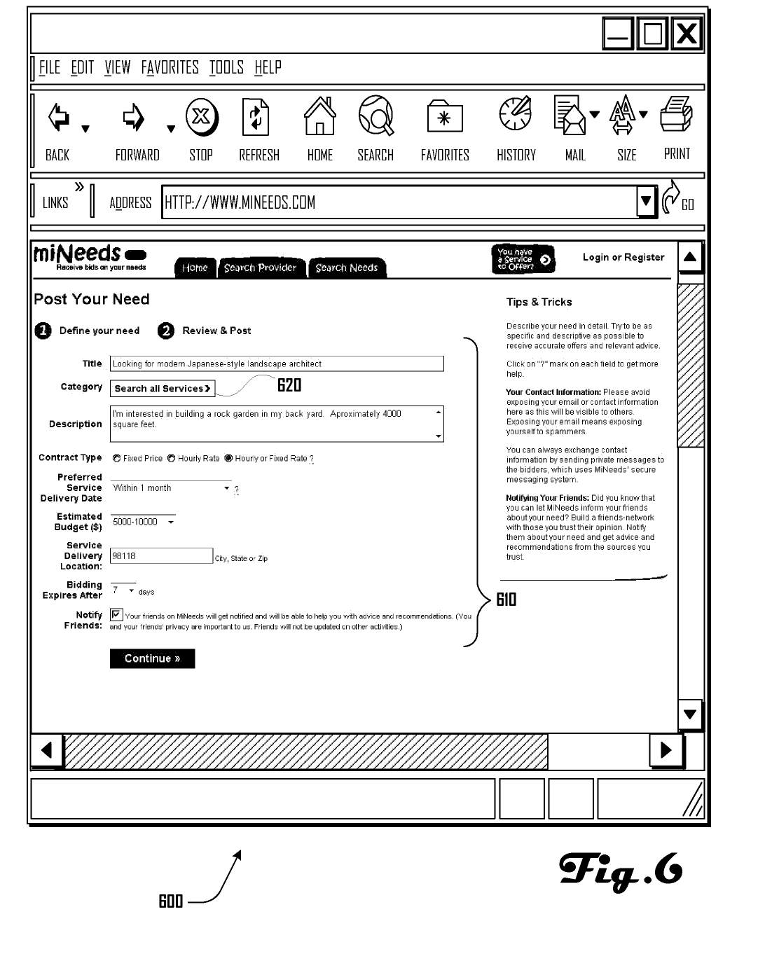

FIG. 6 is an illustration of a graphic user interface comprising a desire posting module 600, in accordance with various embodiments. The posting desire module 600 comprises a desire input field 610, which further comprises a provider definition field 620. As depicted in FIG. 6, a user may create a title, description, select desire billing method, delivery date, budget, user location, expiration of desire posting, and the like. It should be clear to one of ordinary skill in the art that a desire posting may comprise a multitude of different attributes and any one is within the scope and spirit of various embodiments.

In some embodiments, a user may select one or more provider definition from one or more level of a nested hierarchical taxonomy. In other embodiments, a user may define desired provider attributes, such as provider location, business size, years of experience, contract type, gender, religion, age, qualifications, and the like. In yet another embodiment a user may define user attributes, such as age, location, budget, religion, gender, payment preferences, and the like.

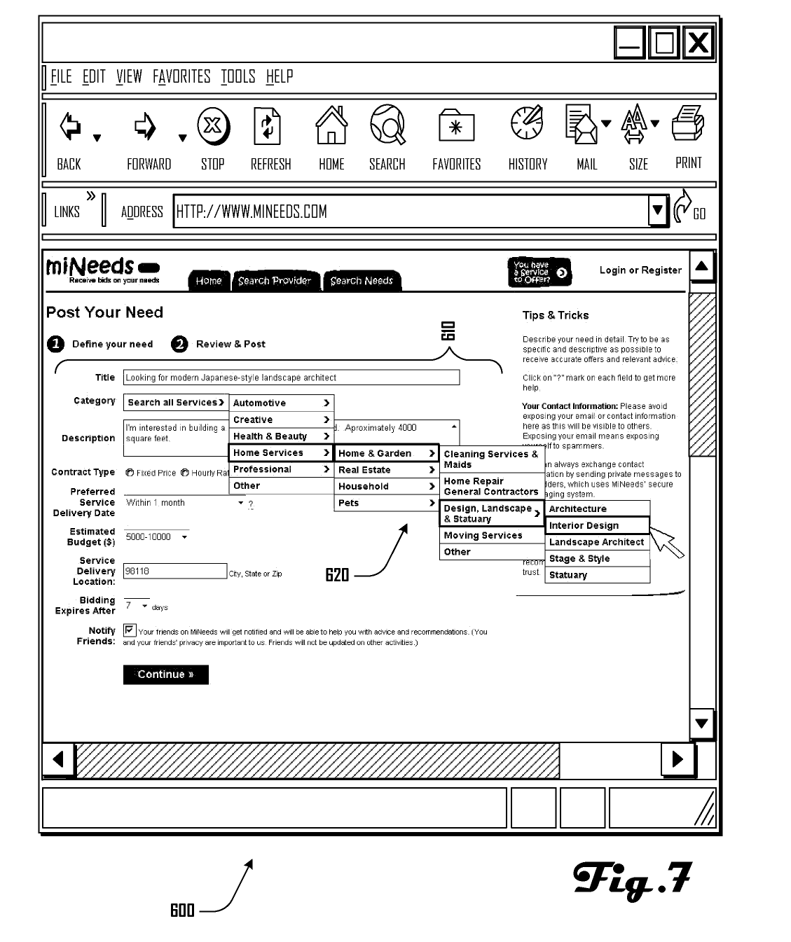

FIG. 7 is an illustration of a graphic user interface comprising a desire posting module 600, in accordance with various embodiments. The posting desire module 600 comprises a desire input field 610, which further comprises a provider definition field 620. As shown in FIG. 7, the provider definition field 620 may allow a user to select a provider definition from within a nested hierarchical taxonomy. The nested hierarchical taxonomy may comprise one or more levels, wherein each level may comprise one or more definitions of goods and/or services. The definitions in primary levels may begin broadly, and become more specific in subsequent levels. In various embodiments the nested hierarchical taxonomy may be analogous to zoological classification of living creatures. For example, as shown in FIG. 7, a user is depicted selecting “Interior Design,” where “Home Services” is the definition the definition at a primary definition level; “Home & Garden” is at a secondary definition level; “Design, Landscape, & Statuary” is at a tertiary definition level; and “Interior Design” is at a quaternary definition level.

In one embodiment, the nested hierarchical taxonomy is extensible by a user. For example, a user may add a provider definition to any level of the nested hierarchical taxonomy if the user so desires. In some embodiments, a user device 110 and/or a provider device 130 may modify, add, or remove a provider definition to any level of the nested hierarchical taxonomy or modify, add, or remove any level of the nested hierarchical taxonomy.

In another embodiment, a user may generate a user profile and associate a desire posting with the user profile. Additionally, the user may associate other user profiles, defined as “friends”, “associates”, “contacts”, or the like. Additionally, as depicted in FIG. 7, a user creating a desire posting may choose to publicize or send the desire posting to the user's “friends”, “associates”, “contacts”, or the like.

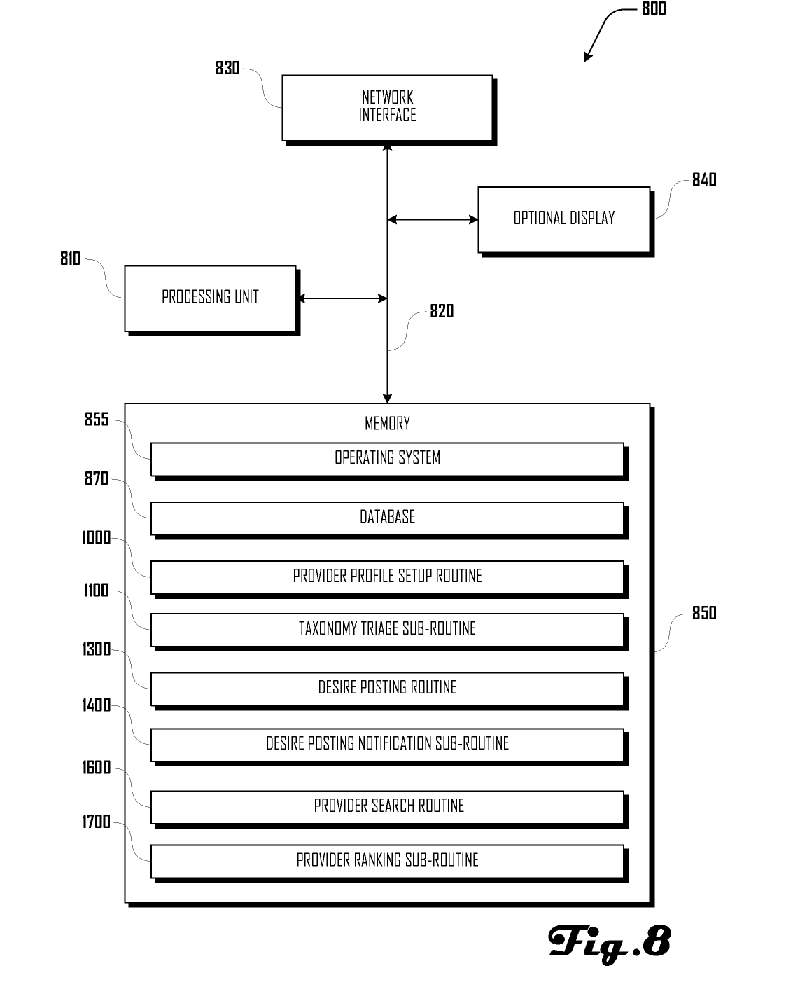

FIG. 8 illustrates several components of an exemplary operating environment 800 for an embodiment. For example, a host server 800 may be embodied in the operating environment 800 depicted in FIG. 8. Those of ordinary skill in the art and others will appreciate that the operating environment 800 may include many more components than those shown in FIG. 8. However, it is not necessary that all of these generally conventional components be shown in order to disclose an enabling embodiment for practicing the embodiments described herein. As shown in FIG. 8, the operating environment 800 includes a network interface 830 for connecting to remote devices (not shown). The network interface 830 may be a network interface designed to support a local area network (“LAN”), wireless local area network (“WLAN”), personal area network (“PAN”), Worldwide Interoperability for Microwave Access (“WiMax”), telephone network, pager network, powerline connection, serial bus, universal serial bus (“USB”) wireless connection, or the like. The network interface 830 includes the necessary circuitry, driver and/or transceiver for such a connection and is constructed for use with the appropriate protocols for such a connection.

The operating environment 800 also includes a processing unit 810, an optional display 840 and a memory 850, all interconnected along with the network interface 830 via a bus 820. Those of ordinary skill in the art and others will appreciate that the display 840 may not be necessary in all forms of computing devices and, accordingly, is an optional component. The memory 850 generally comprises random access memory (“RAM”), a read only memory (“ROM”) and a permanent mass storage device, such as a disk drive, flash RAM, or the like. The memory 850 stores the program code necessary for a provider profile setup routine 1000, a taxonomy triage sub-routine 1100, a desire posting routine 1300, a desire posting notification sub-routine 1400, a provider search routine 1600, and a provider ranking sub-routine 1700. Additionally, the memory 850 stores an operating system 855 and a database 870.

It will be appreciated that the software components may be loaded from a computer readable medium into memory 850 of the operating environment 800 using a drive mechanism (not shown) or network mechanism (not shown) associated with the computer readable medium, such as a floppy, tape, digital video disc (DVD)/CD-ROM drive, flash RAM, network interface card, or the like.

Although an exemplary operating environment 800 has been described that generally conforms to conventional general-purpose computing device, those of ordinary skill in the art will appreciate that a operating environment 800 may be any of a great number of devices capable of functioning as a device, server or operating environment that is within the spirit or scope of the embodiments described herein or may perform at least one function of the embodiments described herein.

In one exemplary embodiment, a user device 110 or a provider device 130 may configure or interact with the operating environment 800 using a graphical user interface. An example of a graphical user interface is an interactive web page, e.g., in HTML (HyperText Markup Language), Flash, JavaScript, VBScript, JScript, ASP.NET, PHP (HTML Preprocessor) or XHTML (eXtensible HyperText Markup Language) form, or the like. Resultantly, since users are generally familiar with the user interfaces of web pages, including sophisticated web pages such as Flash-enabled web pages from Macromedia, Incorporated of San Francisco, Calif., consumption of peer to peer device services using a web page based graphical user interface on a peer to operating environment 800 (e.g., displayed on the peer to peer display 840) may be made familiar and user friendly.

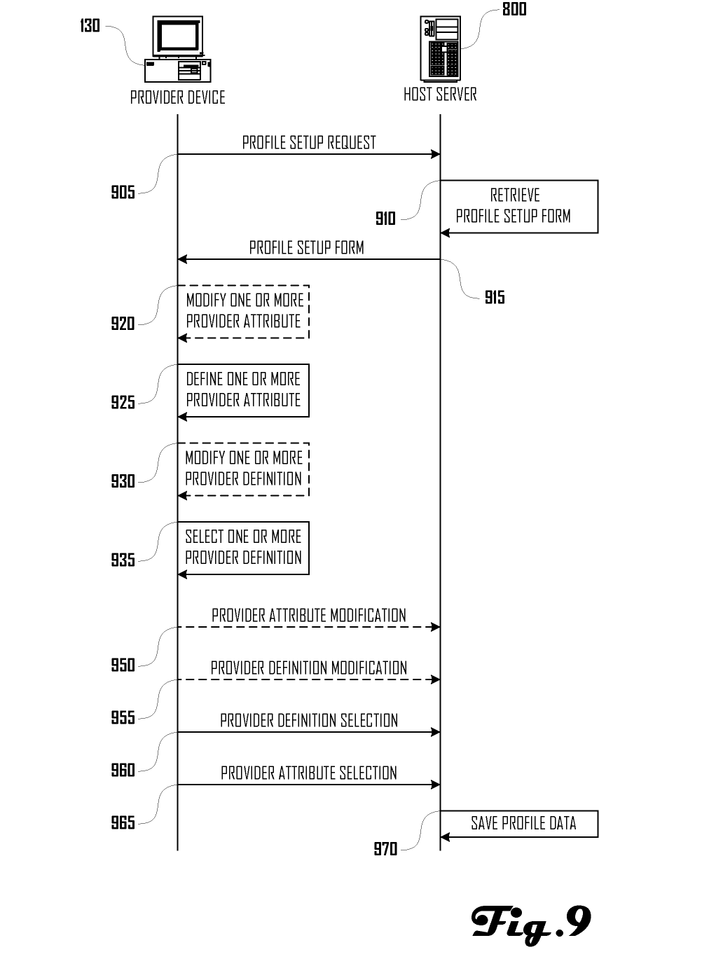

FIG. 9 is a diagram illustrating the actions taken by a provider device 130 and a host server 800 in accordance with various embodiments. The actions begin where a profile setup request is sent 905 to the host server 800. The host server 800 retrieves 910 the profile setup form and presents 915 the profile setup form to the provider device 130. The provider device 130 defines 925 one or more provider attribute and selects 935 one or more provider definition (see, e.g. FIGS. 3, 4 and 5).

In optional steps, the provider device 130 may modify 920 one or more provider attribute; define 925 one or more provider attribute, (which may or may not include the one or more modified 920 provider attribute); modify 930 one or more provider definition; and select 935 one or more provider definition (which may or may not include the one or more modified 930 provider definition). In one embodiment, modification 930 of a provider definition or modification 920 of a provider attribute may include addition, deletion, re-categorization, editing, or the like, of a provider definition within an extensible nested hierarchical taxonomy. In one embodiment, provider device 130 may perform one or more of modifying 920 one or more provider attribute and modifying 930 a provider definition.

Returning to the actions of FIG. 9, provider definition selection is sent 960 to the host server 800 and a provider attribute selection is sent 965 to the host server 800, where the profile data is saved 970. In an optional step, where a provider modifies 930 a one or more provider definition, the provider definition modification 930 is sent 955 to the host server 800, where it is saved 970 along with other profile data. In another optional step, where a provider modifies 920 a one or more provider attribute, the provider attribute modification is sent 950 to the host server, where it is saved 970 along with other profile data.

For example, in one embodiment, a provider device 130 may visit a website and be presented with a profile module 300, where the provider device 130 may define and/or select one or more provider attribute and provider definition. Additionally, the provider device 130 may modify nested hierarchical taxonomy associated with provider attributes and/or provider definitions. The profile data may be submitted 950, 955, 960, 965 to the host server 800 and the profile may be saved 970. In some embodiments, a saved profile may be published such that the profile may be viewed and/or searched by other provider devices 130 and/or user devices 110.

In another embodiment, a provider may upload or provide a link to a video or audio file that may be associated with the provider profile. In yet another embodiment, where a provider profile comprises one or more webpage, provider attributes and/or selected definitions may be incorporated into the webpage in text and meta-data. In various embodiments, this may be desirable because it may promote search engine optimization (“SEO”) of the provider profile.

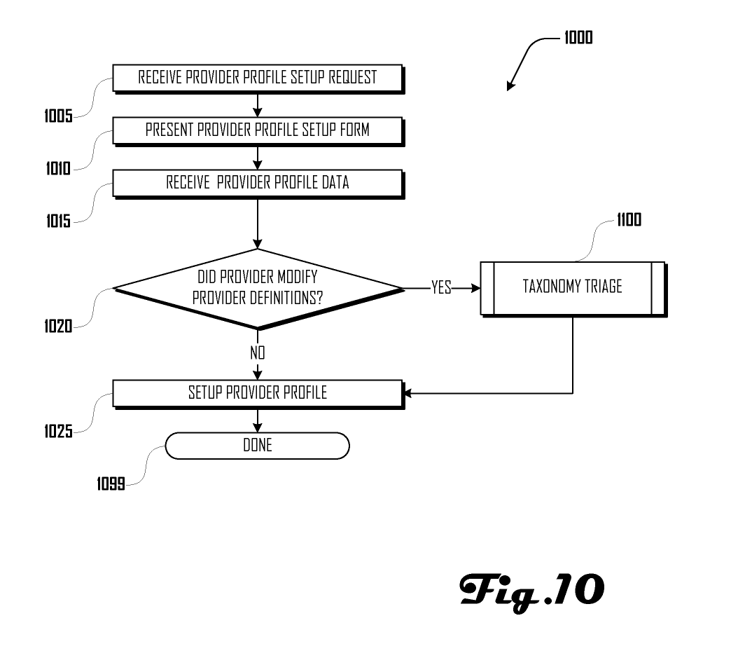

FIG. 10 is a flow diagram illustrating a provider profile setup routine 1000 in accordance with various embodiments. The provider profile setup routine 1000 begins in block 1005 where a profile setup request is received. In block 1010 a provider profile setup form is presented 1010 and provider profile data is received in block 1015.

In decision block 1020 a determination is made whether modifications were made to provider definitions, and if so the provider profile setup routine 1000 proceeds to block 1100, where a taxonomy triage sub-routine is performed. The provider profile setup routine 1000 proceeds to block 1025 where a provider profile is setup, and then the routine is done 1099. However, if the provider did not modify the provider definitions, the provider profile setup routine 1000 proceeds to block 1025 where the provider profile is setup and the routine is done 1099.

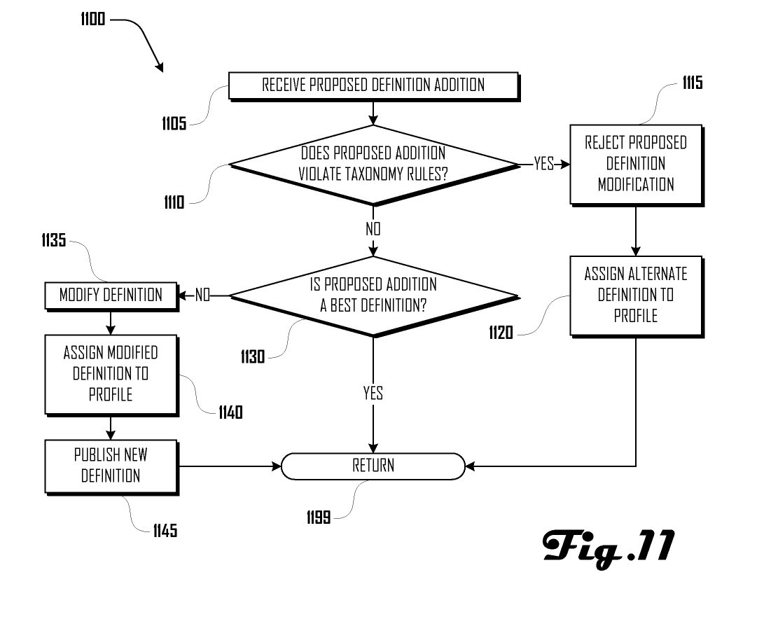

FIG. 11 is a flow diagram illustrating a taxonomy triage sub-routine 1100 in accordance with various embodiments. The taxonomy triage sub-routine 1100 begins in block 1105 where a proposed definition addition is received. The taxonomy triage sub-routine 1100 continues to decision block 1110 where a determination is made whether the proposed definition addition violates taxonomy rules, and if so, the taxonomy triage sub-routine 1100 continues to block 1115 where the proposed definition addition is rejected. The taxonomy triage sub-routine 1100 continues to block 1120 where an alternative definition is assigned to the profile and the taxonomy triage sub-routine 1100 then returns 1199.

However, if the proposed addition does not violate taxonomy rules, then the taxonomy triage sub-routine 1100 continues to decision block 1130, where a determination is made whether the proposed definition is the best definition and the taxonomy triage sub-routine 1100 then returns 1199.

However, if the proposed addition is not a best definition, then the taxonomy triage sub-routine 1100 continues to block 1135 where the definition is modified. The taxonomy triage sub-routine 1100 then continues to block 1140 where the modified definition is assigned to the profile and then continues to block 1145 where the new definition is published. The taxonomy triage sub-routine 1100 then returns 1199.

In one embodiment, the exemplary taxonomy triage sub-routine 1100 depicted in FIG. 11 may apply to any modification, addition, deletion, re-categorization, or any other type of configuration of definitions within a nested hierarchical taxonomy. Regarding taxonomy rules, such rules may be defined by a host server 800 administrator. For example, taxonomy rules could relate to duplicative definitions, definitions categorized within an inappropriate level, definitions being too broad, inappropriate deletion of a definition or level, inappropriate creation of a new level, obscene subject matter, and the like. In some embodiments, a determination as to whether taxonomy rules are violated may be performed by a computer system or other automated process or may be performed by a human operator.

Similarly, proposed definitions may not be a “best definition” according to various criteria. For example, a best definition may be defined by the frequency of use of the term when such goods and/or services are described. In one embodiment, popularity of a given term or string of terms may be determined by consulting most common searches of an Internet search engine such as Google.com® or Yahoo.com®. In one example, a proposed provider definition may be “Car Maintenance Worker”; however, the term “Mechanic” may be determined to be a superior definition for persons who service automobiles. In various embodiments, such a determination may be made by a computer system or other automated system or may be made by a human operator.

In another embodiment, the taxonomy triage sub-routine 1100 may be applied to provider attributes, provider definitions, user attributes, and the like. Accordingly, in various embodiments, any user or provider input may be reviewed to determine if the input violates taxonomy rules or is the best definition for the goods and/or services, and/or attributes sought to be defined. In some embodiments, a taxonomy triage sub-routine 1100 may be desirable to promote a user extensible nested hierarchical taxonomy that provides for user extensibility but also maintains quality control standards.

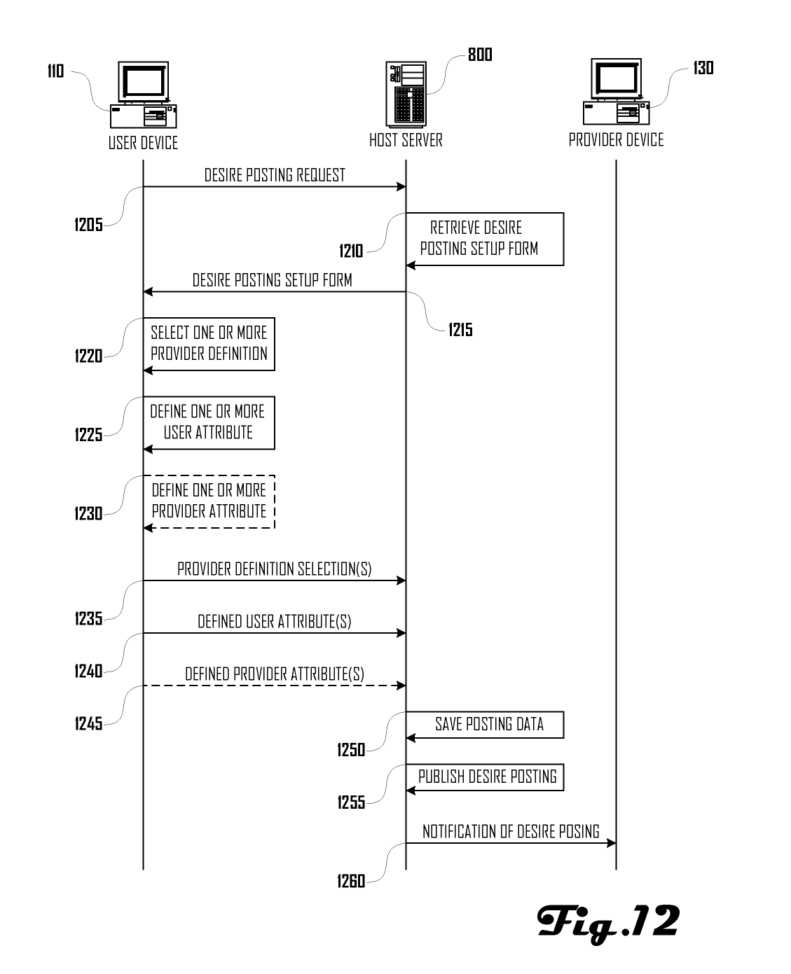

FIG. 12 is a diagram illustrating the actions taken by a user device 110, a host server 800, and a provider device 130, in accordance with various embodiments. The actions begin where a desire posting request is sent 1205 to the host server 800. The host server 800 retrieves 1210 a desire posting setup form and presents 1215 the desire posting setup form to the user device 110. The user device 110 selects 1220 one or more provider definition, defines 1225 one or more user attribute, and in an optional step may define 1230 one or more provider attribute. (See, e.g. FIGS. 6 and 7)

For example, a user may be presented with a desire posting module 600 and may select 1220 one or more provider definition from a nested hierarchical taxonomy corresponding to goods and/or services desired by the user. The user may also define one or more user attribute, which may include attributes such as user location, user zip-code, user address, user age, user religion, user budget, user payment method, user language, and the like. Additionally, the user may define 1230 one or more provider attribute, such as desired provider proximity, experience, credentials, hours of operation, gender, religion, spoken language, and the like.

Returning to the actions, provider definition selections are sent 1235 to the host server 800, defined user attributes are sent 1240 to the host server 800, and where the user defined 1230 one or more provider attribute, such provider attributes may be sent 1245 to the host server 800. Desire posting data sent 1235, 1240, 1245 to the host server 800 is saved 1250 and the desire posting is published 1255. A notification is then sent 1260 to one or more provider device 130.

For example, a host server 800 may receive desire posting data, format and save 1250 the desire posting, and publish 1255 the desire posting such that it may be observed and/or searched by provider devices 130 and/or other user devices 110. Notice of the desire posting may be sent 1260 to one or more provider device 130 and/or user devices 110. Criteria for sending 1260 notice of a given desire posting may include correlation to provider definitions, user attributes, or provider attributes defined or selected in the desire posting. In another embodiment, criteria for sending 1260 a notification of a desire posting may include association with the user profile associated with the desire posting.

In various embodiments, providers can communicate with users or posters of desire postings. For example, a provider can receive notice of a relevant desire posting and can e-mail, telephone, text message or otherwise communicate with the user associated with the desire posting. Alternatively, a provider may search for desire postings and respond to the posting.

In one embodiment, a provider can submit a bid for the opportunity to provide the goods and/or services desired and the bid can be public or private. In another embodiment, a plurality of providers can bid for the opportunity to provide the goods and/or services desired. As used herein, a bid may be various types of communications, which may include a proposal, offer, acceptance of an offer, or the like. In a still further embodiment, any user or provider can submit a comment, suggestion, piece of advice, or referral to a user associated with a desire posting.

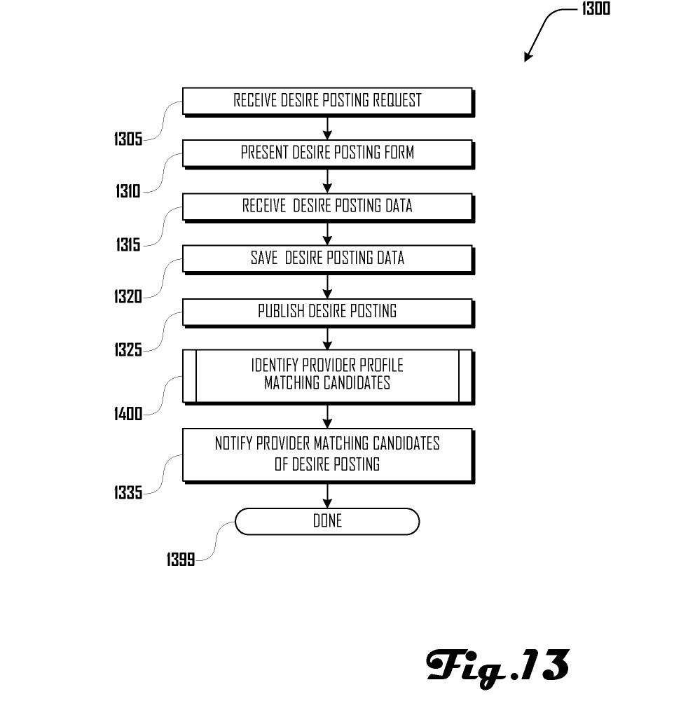

FIG. 13 is a flow diagram illustrating a desire posting routine 1300 in accordance with various embodiments. The desire posting routine 1300 begins in block 1305 where a desire posting request is received and continues to block 1310 where a desire posting form is presented. In block 1315, desire posting data is received and in block 1320 desire posting data is saved. In block 1325 the desire posting is published. In block 1400 provider profile matching candidates are identified and in block 1335 identified provider matching candidates of the desire posting are notified. The desire posting routine 1300 is then done 1399.

In one embodiment, desire posting data may be used to present advertisements to a user based on correlation to the desire posting data. For example, if a user posts a desire posting relating to hiring a modern Japanese-style landscape architect to build a rock garden (see, e.g. FIGS. 6 and 7) the user may be presented with advertisements relating to landscaping, Japanese-style products, home care, gardening, landscaping materials, and the like.

In one embodiment, a user may be presented with advertisements only when a given desire posting is pending or active. This may be desirable in various embodiments because a user's needs or desires may be transient and once a given need or desire has been satisfied, advertisements relating to that need or desire may no longer be relevant to the user. In other embodiments, content and data from desire postings associated with a given user or user profile may be saved and used to present advertisements to the user. In some embodiments, a provider definition, provider attribute, user attribute, or the like, may be used to select advertisements that are presented to a user.

In a further embodiment, a provider can be presented with advertisements, which can be based on provider attributes, provider definitions, provider bid data, user attributes, and the like. For example, a provider of legal services may be presented with advertisements relating to legal research services, expert witnesses, business support services, and the like. In another example, a provider of building services could be presented with advertisements for building supplies, tools, or the like. In a further example, a provider of building services that frequently responds to desire postings relating to tiling may be presented with more advertisements that relate to tiling supplies or tools in addition receiving advertisements relating to tools, supplies and/or services that would be relevant to a provider of general building services.

In various embodiments, it may be desirable to base advertisement presentation on provider attributes, selected provider definitions, or selected user attributes, instead of keywords, because irrelevant advertisements may thereby be excluded from presentation. For example, a provider of legal services could receive advertisements that are relevant to a provider of legal services instead of advertisements for providers of legal services, which would likely be presented if advertisement presentation was based solely on keywords.

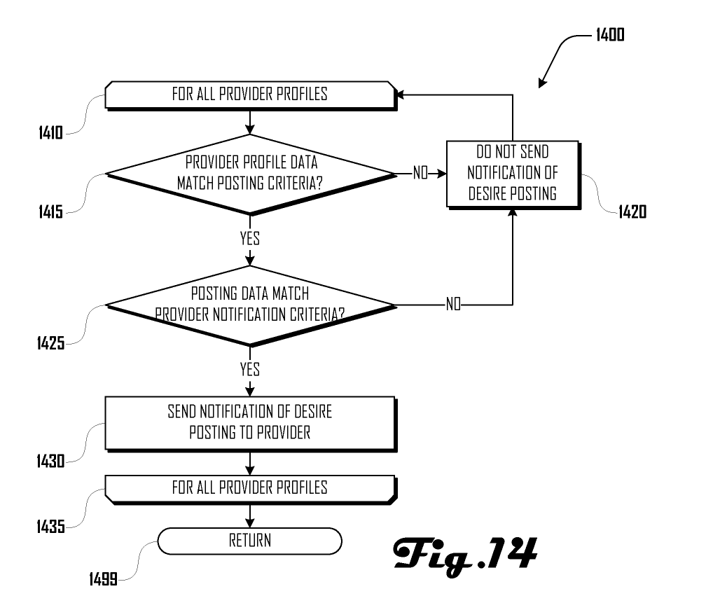

FIG. 14 is a flow diagram illustrating a desire posting notification sub-routine 1400 in accordance with various embodiments. The desire posting notification sub-routine 1400 begins in looping block 1410, which begins a loop for all provider profiles. In block 1415 a determination is made whether provider profile data matches posting criteria, and if so, the desire posting notification sub-routine 1400 continues to decision block 1425 where a determination is made whether posting data matches provider notification criteria. If the posting data matches provider criteria, then the desire posting notification sub-routine 1400 continues to block 1430 where a notification of the desire posting is sent to the provider. Looping block 1435 ends the loop for all provider profiles and the desire posting notification sub-routine 1400 returns 1499.

However, if the provider profile data does not match posting criteria or if posting data does not match provider notification criteria, the desire posting notification sub-routine 1400 continues to block 1420 and a notification is not sent regarding the desire posting. The desire posting notification sub-routine 1400 then continues the loop for all provider profiles.

For example, a determination may be made whether a provider profile matches posting criteria, and such criteria may include goods and/or services offered by the provider, provider experience, provider credentials, provider hours of operation, provider billing options, and the like. Additionally, a determination may be made whether a given desire posting or user criteria matches provider notification criteria, which may include criteria such as user identity, user location, service location, shipping location, user age, user nationality, user budget, user gender and the like.

In various embodiments, such a method may be desirable because providers may only want to be notified of relevant desire postings that relate to goods and/or services offered by the provider. Similarly, a user posting a desire posting may only desire to receive responses from relevant providers, and therefore may not desire that a posting desire notification be sent to irrelevant providers.

Additionally, a provider may have additional limitations on their willingness or ability to provide certain goods and/or services to certain persons or companies, and the provider may only want to receive notifications of desire postings matching these criteria. For example, a house cleaner may only operate in a certain geographical area, a tutor may only work with children of a given age, a female massage therapist may desire to only work with women, a seller of tobacco or alcohol may not be able to sell to persons of a certain age, a seller of wine products may not be able to ship wine to certain states, an attorney may not be licensed to practice in a given state, and the like.

In one embodiment, screening for a match to posting criteria or a match to provider notification criteria may be absent, or performed in any order. In another embodiment, such screening may be performed by a computer system or other automated system or by a human operator.

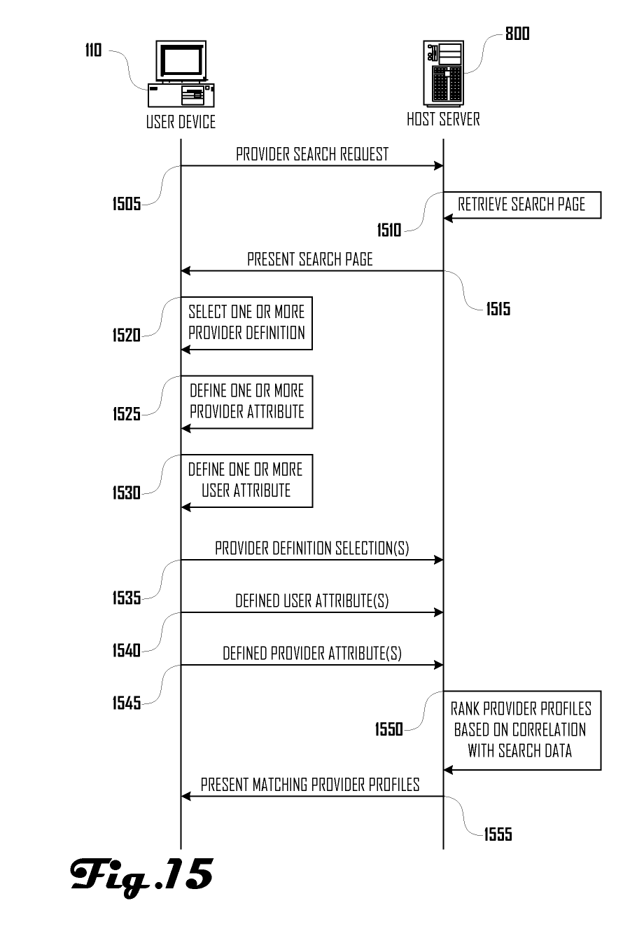

FIG. 15 is a diagram illustrating the actions taken by a user device 110 and a host server 800 in accordance with various embodiments. The actions begin where a provider search request is sent 1505 to the host server 800. The host server 800 retrieves 1510 a search page and presents 1515 the search page to the user device 110. The user device 110 selects 1520 one or more provider definition, defines 1525 one or more provider attribute and defines 1530 one or more user attribute. Provider definition selections, defined user attributes, and desired provider attributes are sent 1535, 1540, 1545 to the host server 800. Provider profiles are then ranked 1550 based on correlation to search data and matching provider profiles are presented 1555 to the user device 110.

For example, a user device 110 may submit 1535, 1540, 1545 a search for provider profiles that most closely match a set of criteria defined by the user device 110. The criteria may include correspondence to provider definitions from a nested hierarchical taxonomy, correspondence to provider attributes, and correspondence to user attributes. Search criteria may be compared to a plurality of provider profiles, the provider profiles may be ranked 1550 by correspondence to the search criteria, and the user device 110 may be presented with a list of provider profiles in order of rank, which may represent providers having greatest correlation to search criteria. (See, e.g. FIG. 2).

In some embodiments, certain search criteria may have more or less weight in determining provider profile correlation to the search criteria. For example, a tall female Catholic user may be looking for a massage therapist that lives close to the user's home, and would like such a provider to have several years of experience. The user may also prefer the provider to also be female, tall and Catholic. Accordingly, such a user could submit a search for a massage therapist within close radius of the user's house, that has 5-10 years of experience, and is female, over 6 feet tall, and of the Catholic faith. In various embodiments, it may not be desirable to give each of these criteria equal weight when determine relevance. For example, a user may not find search results relevant if a tall, female, Catholic architect with 10 years of experience was found highly corresponding to the search criteria.

Accordingly, criteria such as provider services offered, years of experience, and proximity to user may receive greater weight when rating correlation to search criteria, and criteria such as height, religion, and gender may receive less weight when rating relevance. In some embodiments, a user may select criteria that are more important than other criteria, criteria that must be present, criteria that are less important than other criteria, and the like.

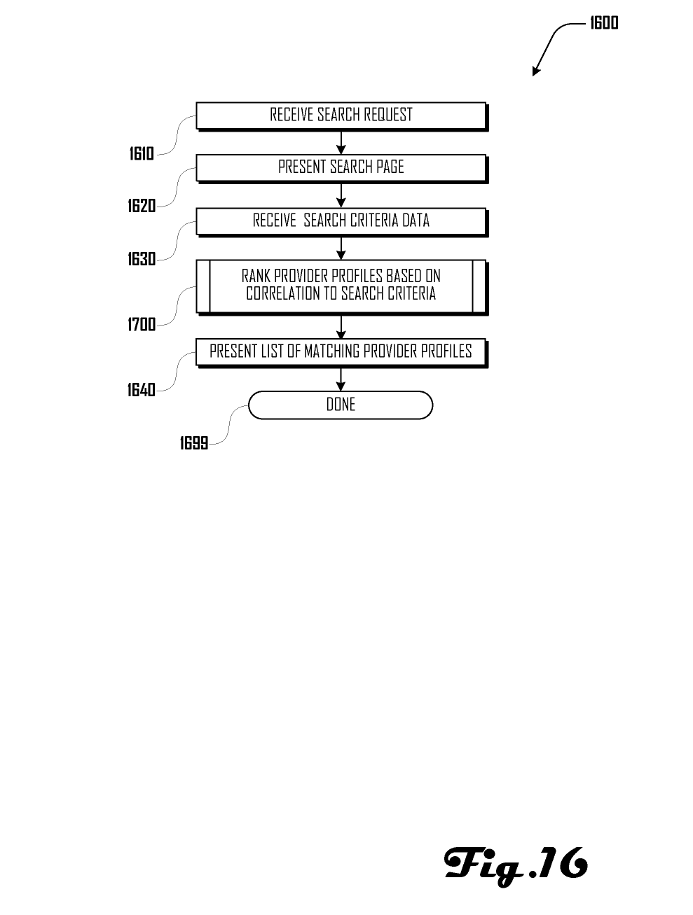

FIG. 16 is a flow diagram illustrating a provider search routine 1600 in accordance with various embodiments. The provider search routine 1600 begins in block 1610, where a search request is received. In block 1620 a search page is presented and in block 1630 search criteria data is received. In sub-routine block 1700 provider profiles are ranked based on correlation to search criteria and in block 1640 a list of matching providers is presented. The provider search routine 1600 is then done 1699.

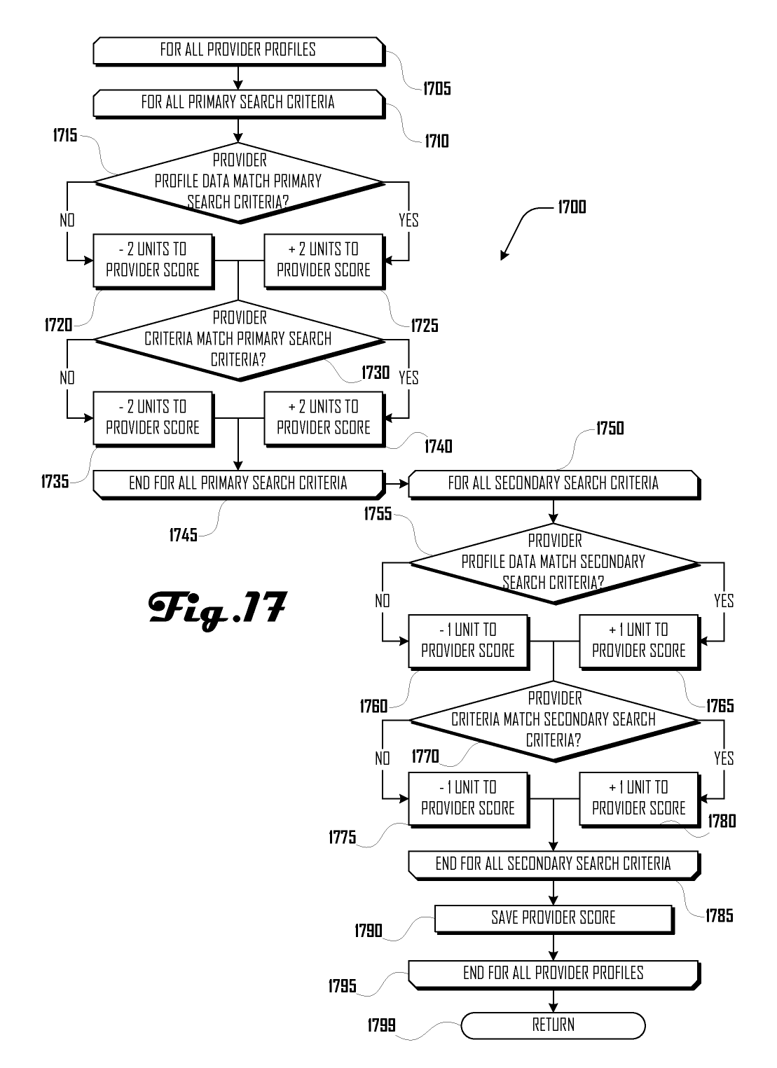

FIG. 17 is a flow diagram illustrating a provider ranking sub-routine 1700 in accordance with various embodiments. The provider ranking sub-routine 1700 begins in looping block 1705, which begins a loop for all provider profiles, and looping block 1710 begins a loop for all primary search criteria. The provider ranking sub-routine 1700 proceeds to block 1715 where a determination is made whether provider profile data matches primary search criteria, and if so, +2 units are added to the a provider score in block 1725, and if not, 2 units are subtracted from the provider score in 1720

In block 1730, a determination is made whether provider criteria match primary search criteria and if so +2 units are added to the provider score in block 1740, and if not, 2 units are subtracted from the provider score in block 1735. Looping block 1745 end the loop for all primary search criteria and looping block 1750 begins a loop for all secondary search criteria 1750.

In block 1755, a determination is made whether provider profile data match secondary search criteria, and if so, +1 unit is added to the provider score in block 1765, and if not, 1 unit is subtracted from the provider score in block 1760. In block 1770, a determination is made whether provider criteria match secondary search criteria, and if so, +1 unit is added to the provider score in block 1780, and if not, 1 unit is subtracted from the provider score in block 1775. Looping block 1785 ends the loop for all secondary search criteria, and the provider score is saved in block 1790. Looping block 1795 ends the loop for all provider profiles and the provider ranking sub-routine 1700 then returns.

One of ordinary skill in the art should appreciate that the provider ranking sub-routine 1700 is simply an exemplary sub-routine, and that a similar routine may be provided that may comprise a plurality of search criteria levels, i.e. primary, secondary, tertiary, quaternary, quinary, senary, septenary, octonary, nonary, denary, duodenary, vigenary, and the like. In a further embodiment, search criteria need not be compared to provider profile data or provider criteria.

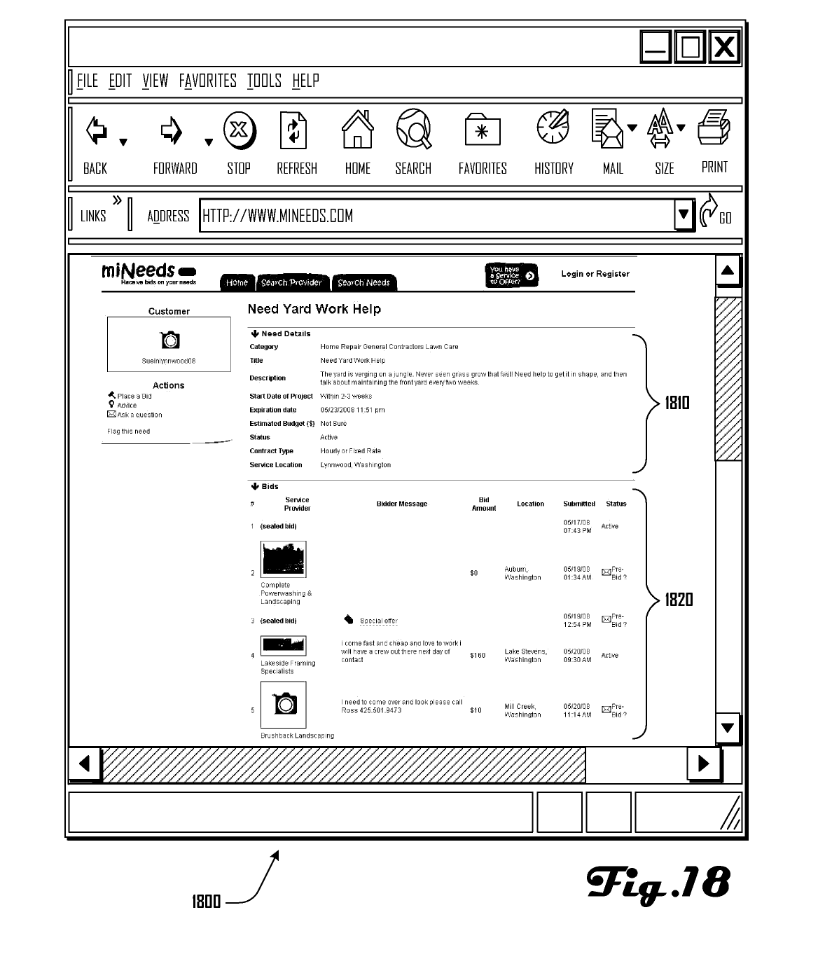

FIG. 18 is an illustration of a graphic user interface comprising a desire posting management module 1800, in accordance with various embodiments. As shown in this exemplary embodiment, a desire posting management module 1800 can comprise a desire posting data field 1810 and a bid field 1820. As described herein, a plurality of providers can bid for the opportunity to provide the goods and/or services desired. As used herein, a bid may be various types of communications, which may include a proposal, offer, acceptance of an offer, or the like. In a still further embodiment, any user or provider can submit a comment, suggestion or referral to a user associated with a desire posting.

In yet another embodiment, bids can be sealed and information about a bid can therefore be hidden from unauthorized users or providers. For example, as depicted in FIG. 18, some information regarding a bid may be visible to other users or providers and all information regarding a sealed bid may be visible to the user that posted the bid.

In some embodiments, a bid can comprise various types of information or data, which may include a picture, a provider location, a provider attribute, a user attribute, a provider definition, a special offer, provider contact information, a price of goods and/or services, or the like. In an embodiment wherein a bid comprises a special offer, the bid may comprise an incentive such as a coupon, discount, free service, or the like. In another embodiment, a bid can be edited, updated or modified by a provider placing a bid. In yet another embodiment, a user can accept one or more bid among a plurality of bids, reject one or more bid, make a counter offer, or make a bid for services.

For example, as shown in FIG. 18, a user may have a desire for assistance with yard work and can post a desire posting to publicize the user's desire. The user may receive a plurality of bids from a plurality of providers and the user can choose to accept one or more bid. In some embodiments, it may be desirable to associate provider data with a bid because a user may choose to accept a given bid based on criteria aside from price. For example, a user may choose to accept a bid because a given provider is bonded or licensed, has more experience that other bidding providers, knows CPR or other emergency procedures, is insured, or the provider may have positive reviews from other users.

In one embodiment a provider can communicate with a user associated with a desire posting instead of submitting a bid, which can include sending an e-mail, sending text message, posting a message, making a telephone call, or the like. In another embodiment, a user can communicated with a bidding provider via similar methods.

It should be clear to one of ordinary skill in the art that bidding and other functionalities described herein can be applied to various social networking, desire posting, or desire searching scenarios. Accordingly, systems and methods described herein can be applied to dating or relationship matching, matching activity partners, searching for an employer, searching for an employee, or the like.

Additionally, although specific embodiments have been illustrated and described herein, it will be appreciated by those of ordinary skill in the art and others, that a wide variety of alternate and/or equivalent implementations may be substituted for the specific embodiment shown and/or described without departing from the scope of the embodiments described herein. This application is intended to cover any adaptations or variations of the embodiment discussed herein. While various embodiments have been illustrated and described, as noted above, many changes may be made without departing from the spirit and scope of the embodiments described herein.

1. A computer implemented method of advertising goods and/or services, advertising a desire for goods and/or services, and searching for providers of goods and/or services, the method comprising:
providing an extensible nested hierarchical taxonomy comprising provider definitions corresponding to a plurality of goods and/or services;
receiving a provider modification of said extensible nested hierarchical taxonomy comprising provider definitions;
receiving a provider profile comprising:
a selection of a provider definition corresponding to goods and/or services offered by a provider associated with said provider profile, and
a provider attribute corresponding to said provider;
receiving a user desire posting comprising
a user attribute,
a posting selection of a provider definition, and
a posting selection of a provider attribute;
selectively notifying at least one provider of said user desire posting based on
said posting selection of a provider definition, and
at least one of said user attribute and said posting selection of a provider attribute;
receiving a user search request comprising:
a search selection of a provider definition, and
a search selection of a provider attribute; and
selectively presenting one or more provider profile based on
said search selection of a provider definition, and
said search selection of a provider attribute.

2. The method of claim 1, further comprising:
providing an extensible nested hierarchical taxonomy comprising provider attributes, and
wherein said provider profile further comprises a provider modification of said extensible nested hierarchical taxonomy comprising provider attributes.

3. The method of claim 1, wherein said provider modification of said extensible nested hierarchical taxonomy comprising provider definitions is an addition of a provider definition.

4. The method of claim 1, wherein said user search request further comprises a user attribute.

5. The method of claim 4, wherein said presenting one or more provider profile is further based on a user attribute.

6. The method of claim 1, wherein said selectively notifying at least one provider of said user desire posting is based on said user attribute and said posting selection of a provider attribute.

7. The method of claim 1, wherein said provider modification of said extensible nested hierarchical taxonomy comprising provider definitions is subjected to taxonomy triage.

8. The method of claim 7, wherein said taxonomy triage comprises a determination of whether said provider modification of said extensible nested hierarchical taxonomy comprising provider definitions violates a taxonomy rule.

9. The method of claim 8, wherein said taxonomy triage further comprises a determination of whether said provider modification of said extensible nested hierarchical taxonomy comprising provider definitions is a best definition.

10. The method of claim 9, wherein said taxonomy triage is performed by a human operator.

11. The method of claim 2, wherein said provider modification of said extensible nested hierarchical taxonomy comprising provider attributes is subjected to taxonomy triage.

12. The method of claim 11, wherein said taxonomy triage comprises a determination of whether said provider modification of said extensible nested hierarchical taxonomy comprising provider attributes violates a taxonomy rule.

13. The method of claim 12, wherein said taxonomy triage further comprises a determination of whether said provider modification of said extensible nested hierarchical taxonomy comprising provider attributes is a best definition.

14. The method of claim 13, wherein said taxonomy triage is performed by a human operator.

15. The method of claim 1, wherein a plurality of providers can present at least one of a bid, proposal, offer, and piece of advice, in response to said desire posting.

16. The method of claim 1, wherein a provider can search for a desire posting.

17. The method of claim 1, wherein said extensible nested hierarchical taxonomy comprising provider definitions is extensible by a user.

18. The method of claim 17, wherein said extensible nested hierarchical taxonomy comprising provider attributes is extensible by a user.

19. The method of claim 1, further comprising:
providing an extensible nested hierarchical taxonomy comprising user attributes, and
wherein said extensible nested hierarchical taxonomy comprising user attributes is extensible by a user.

20. An apparatus for advertising goods and/or services, advertising a desire for goods and/or services, and searching for providers of goods and/or services, the apparatus comprising:
a database comprising a nested hierarchical taxonomy comprising provider definitions corresponding to a plurality of goods and/or services;
a provider profile means operable for
receiving a provider definition addition to said nested hierarchical taxonomy;
receiving a provider profile comprising:
a selection of a provider definition corresponding to goods and/or services offered by a provider associated with said provider profile; and
a provider attribute corresponding to said provider;
a user desire posting means operable for
receiving a user desire posting comprising,
a user attribute,
a posting selection of a provider definition, and
a posting selection of a provider attribute; and
selectively notifying at least one provider of said user desire posting based on,
said posting selection of a provider definition, and
at least one of said user attribute and said posting selection of a provider attribute; and
a search means operable for
receiving a user search request comprising
a search selection of a provider definition,
a search selection of a provider attribute; and
selectively presenting one or more provider profile based on
said search selection of a provider definition, and
said search selection of a provider attribute.
